(19) United States
(12) Patent Application Publication
(10) Pub. No.: US 2022/0247177 A1
(43) Pub. Date: Aug. 4, 2022

(54) Photovoltaic Solar Inverter with an AC Grid Filter Without Inductance

(71) Applicant: Power Electronics España, S.L., Lliria (ES)

(72) Inventors: David Salvo Lillo, Lliria (ES); Abelardo Salvo Lillo, Lliria (ES); Josué Juan Aguilar, Lliria (ES); José Luis Camps Soriano, Lliria (ES); Eusebio Rodrigo Mañez, Lliria (ES)

(21) Appl. No.: 17/584,515

(22) Filed: Jan. 26, 2022

(30) Foreign Application Priority Data
Jan. 27, 2021 (ES) P202130063

(51) Int. Cl. H02J 3/01; H02M 5/12; H02M 7/44; H02J 3/38

(52) U.S. Cl. CPC H02J 3/01; H02M 5/12; H02J 2300/24; H02J 3/381; H02M 7/44

(57) ABSTRACT

The present disclosure provides a photovoltaic solar inverter with an AC grid filter without inductance connectable to the AC grid. The inverter comprises: a power module for converting a DC input voltage into a three-phase AC output voltage; a three-phase AC/AC transformer for adapting the three-phase AC output voltage of the power module to the three-phase AC voltage of the AC grid, which has an inductance “L₂”. The three-phase AC/AC transformer comprises a winding on the grid side with an equivalent inductance “L₁”; a capacitor “C”, connected to the winding of the grid side of the three-phase AC/AC transformer. The equivalent inductance “L₁” of the AC/AC transformer, the capacitor “C” and the inductance “L₂” of the AC grid form a high frequency “LCL” filter, eliminating the inductances provided only for forming the LCL filter. The disclosure also provides an AC grid filter without inductance with an “LLCL” typology.

### CROSS-REFERENCE TO RELATED APPLICATION

This application claims priority to Spanish Patent Application No. P202130063 filed Jan. 27, 2021, the disclosure of which is hereby incorporated by reference in its entirety.

### BACKGROUND OF THE INVENTION

The disclosure relates to photovoltaic solar inverters connected to an alternating current (AC) grid with transformer to AC grid included.

### TECHNICAL FIELD

Dimensions, weight and cost of photovoltaic solar inverters are high, due to the large size and weight of the associated components. There is a need for topologies that reduce the number of components and optimise their location.

### DESCRIPTION OF RELATED ART

The solutions available today implement a filter after each of the direct current/alternating current (DC/AC) converter modules, for the purpose of connecting equipment to the grid and reducing high frequency harmonics. The typical topology of these filters is inductance-capacitance-inductance (LCL), since it provides greater harmonics filtering with fewer inductances and with low grid current distortion.

LCL filters are made up of coils and capacitors having large dimensions and weight.

Primary inductances are the components that occupy the most physical space and that substantially increase the weight of the module and the equipment. As a guideline, the main inductance of an LCL filter has the dimensions and weight indicated below:

| | |
|---|---|
| Width | 480 mm |
| Depth | 301 mm |
| Height | 903 mm |
| Weight | >400 kg |

Taking this information into account, the ballpark dimensions of a common 6-module solar inverter with an integrated medium voltage transformer would be as follows:

| | |
|---|---|
| Width | 6600 mm |
| Depth | 2200 mm |
| Height | 2200 mm |
| Weight | 14 Tn |

The idea, therefore, is to find a configuration which reduces the weight and the dimensions of a solar inverter.

As a document illustrating the state of the art in a general manner, the document entitled “A 60-kW 3-kW/kg Five-Level T-Type SiC PV Inverter With 99.2% Peak Efficiency” by Yanjun et. al, published on 4 Mar. 2018 in “2018 IEEE Applied Power Electronics Conference and Exposition (APEC), 20180304 IEEE” can be mentioned. The document by Yanjun et al. discloses a T-shaped photovoltaic inverter with silicon carbide SiC semiconductors having five levels instead of three to make more efficient use of this technology. To define these levels, two inverters from three levels are coupled together by means of coils. Due to the high switching frequencies in the five-level inverter, these coupling coils work as transformers under no load referred to in this document as “Inter Cell Transformers”, or ICTs, which eliminate the need for the connection to the AC grid to have more additional inductances.

The document “Intercell Transformer (ICT) Design Optimization and Interphase Crosstalk Mitigation of a 100-kW SiC Filter-Less Grid-Connected PV String Inverter” (published on 8 Feb. 2020 in “IEEE Open Journal of Power Electronics, 20200208 IEEE”), also by Yanjun et al., focuses on the optimal sizing of the “Inter Cell Transformers” introduced in the preceding document.

The aforementioned documents achieve an inverter that does not need an additional coil at the AC output to act as a filter. However, none of these documents does so by sizing the output transformer as expressed in the present disclosure since, in practice, what they do is to minimise the output disturbances of the inverter to the point that the inductances which already exist in the apparatus are sufficient for filtering the switching disturbances with little to no modification.

Lastly, it should be indicated that the present disclosure uses the concept of SCR (Short Circuit Ratio) as defined, for example, in Chapter 1 of the document with a section entitled “Short Circuit Ratio (SCR)” and publicly accessible at the following link: https://www.nerc.com/comm/PC_Reliability_Guidelines_DL/Item_4a._Integrating%20_Inverter-Based_Resources_into_Low_Short_Circuit_Strength_Systems_-_2017-11-08-FINAL.pdf

### SUMMARY OF THE INVENTION

To solve the problems indicated above and relating to the excess weight and volume of photovoltaic solar inverters, the present disclosure takes advantage of the transformer that converts the AC voltage at the outlet of the power modules to the voltage of the AC grid to which the solar inverter is connected as part of new filter topologies for the elimination of high frequency harmonics.

A first aspect of the disclosure provides a photovoltaic solar inverter with an AC grid filter without inductance, wherein the inverter is connectable to the AC grid. The photovoltaic solar inverter of the present disclosure comprises:
at least one power module for converting a DC input voltage into a three-phase AC output voltage;
a three-phase AC/AC transformer for adapting the three-phase AC output voltage of the power module to the three-phase AC voltage of the AC grid, which has an inductance “L₂”; wherein the three-phase AC/AC transformer comprises:
   at least one winding on the low voltage side connected to the power module;
   at least one winding on the grid side (medium voltage) connectable in series with the AC grid;
wherein the winding on the low voltage side connected to the power module together with the winding on the grid side (medium voltage) have an equivalent inductance “L₁”; and
a capacitor “C”, connected to the winding of the grid side (medium voltage side) of the three-phase AC/AC transformer.

The equivalent inductance “L₁” (L-) of the AC/AC transformer, the capacitor “C” (-C-) and the inductance “L₂” (-L) of the AC grid form a high frequency “LCL” filter, such that the values of the equivalent inductance “L₁” and of the capacitor “C” are calculated based on the frequency response of the “LCL” filter (to be obtained) according to the following expressions:

$${L}_{1} = \frac{{X}_{c c} \cdot {V}_{n}^{2}}{2 π {f}_{n} \cdot {S}_{n}} and C = \frac{{L}_{1} + {L}_{2}}{{L}_{1} \cdot {L}_{2} \cdot {( 2 π {f}_{res} )}^{2}}$$

wherein:
X_{CC}: is the equivalent impedance of the windings of the three-phase AC/AC transformer, configurable based on the frequency response needed for the LCL filter;
Sₙ: is the nominal power of the transformer;
Vₙ: is the nominal voltage of the transformer on the low side (power module side, usually between 600 and 660V);
fₙ: is the working frequency (usually 50 or 60 Hz);
fᵣₑₛ: is the resonant frequency of the LCL filter;
   and knowing that:
L₂ is the inductance of the AC grid which varies according to the SCR (Short Circuit Ratio) according to the following expression:

$${L}_{2} = \frac{{V}_{n}^{2}}{2 π {f}_{n} \cdot SCR \cdot {S}_{n}} .$$

In one embodiment of the disclosure, the solar inverter may further comprise “n” power modules connected to respective independent windings (multi-windings) on the low voltage side of the three-phase AC/AC transformer, such that the equivalent inductance “L₁” is calculated by means of:

$${L}_{1} = ( x + \frac{( 1 - x ) n}{N} ) \frac{{X}_{c c} \cdot {V}_{n}^{2}}{2 π {f}_{n} \cdot {S}_{n}}$$

wherein “x” is the proportion of impedance of the grid side (single; if, for example, X_{CC} is divided by 50%, x=0.5), “N” is the number of windings of the low working side and “n” is the total number of windings of the low voltage side.

The inverter of the present disclosure can comprise a single DC power BUS for powering the “n” power modules, wherein the single DC BUS is connectable to at least one DC power source. Alternatively, the inverter of the present disclosure can comprise one DC power BUS for each of the “n” power modules, such that each of the “n” power modules is connectable to respective DC power sources.

A second aspect of the disclosure provides a photovoltaic solar inverter with an AC grid LLCL filter without inductance, wherein the inverter is connectable to the AC grid. The solar inverter comprises:
at least one power module for converting a DC input voltage into a three-phase AC output voltage;
a three-phase AC/AC transformer for adapting the three-phase AC output voltage of the power module to the three-phase AC voltage of the AC grid, which has an inductance “Lₚ”; wherein the three-phase AC/AC transformer comprises:
   at least one winding on the low voltage side connected to the power module and with an equivalent inductance “L₁”;
   at least one winding on the low voltage side connected to a capacitor “C”, and with an inductance “L_{c}”;
   at least one winding on the grid side (medium voltage) connectable in series with the AC grid, wherein the winding on the grid side has an equivalent inductance “L_{M}”; and,
the capacitor “C”.

The equivalent inductance “L₁” (L-) of the AC/AC transformer, the inductance “L_{c}” (-L-); the capacitor “C” (-C-) and an inductance “L₂” (-L) resulting from adding the inductance “Lₚ” and the equivalent inductance “L_{M}”, form a high frequency filter with “LLCL” typology, such that the values of the equivalent inductance “L₁” and of the capacitor “C” are calculated based on the frequency response of the “LLCL” filter according to the following expressions:

$${L}_{1} = ( 1 - x ) \frac{{X}_{c c} \cdot {V}_{n}^{2}}{2 π {f}_{n} \cdot {S}_{n}} ; C = \frac{{L}_{1} + {L}_{2}}{( {L}_{1} {L}_{2} + {L}_{c} ( {L}_{1} + {L}_{2} ) ) \cdot {( 2 π {f}_{res} )}^{2}} ;$$

$${L}_{c} = \frac{1}{C \cdot {( 2 π {f}_{res} )}^{2}}$$

wherein:
X_{CC} is the configurable element based on the frequency response needed for the LLCL filter;
x: proportion of impedance of the medium side (single; if, for example, X_{CC} is divided by 50%, x=0.5);
Sₙ is the nominal power of the transformer;
Vₙ is the nominal voltage of the transformer on the low side (power module side);
fₙ is the working frequency of the low side (usually 50 or 60 Hz);
fᵣₑₛ is the resonant frequency of the LLCL filter;
   and knowing that:

L₂=L_{M}+L_{P}, wherein:

$${L}_{m} = ( x ) \frac{{X}_{c c} \cdot {V}_{n}^{2}}{2 π {f}_{n} \cdot {S}_{n}}$$

L_{P} is the inductance of the AC grid which varies according to the SCR (Short Circuit Ratio) according to the following expression:

$${L}_{P} = \frac{{V}_{n}^{2}}{2 π {f}_{n} \cdot SCR \cdot {S}_{n}} .$$

In one embodiment of the disclosure, the solar inverter may further comprise “n” power modules connected to respective independent windings (multi-windings) on the low voltage side of the three-phase AC/AC transformer, such that the equivalent inductance “L₁” is calculated by means of:

$${L}_{1} = ( x + \frac{( 1 - x ) n}{N} ) \frac{{X}_{c c} \cdot {V}_{n}^{2}}{2 π {f}_{n} \cdot {S}_{n}}$$

wherein “x” is the proportion of impedance of the medium side (single; if, for example, X_{CC} is divided by 50%, x=0.5), “N” is the number of windings of the low working side and “n” is the total number of windings of the low voltage side.

For the second embodiment, the inverter of the present disclosure can comprise a single DC power BUS for powering the “n” power modules, wherein the single DC BUS is connectable to at least one DC power source. Alternatively, the inverter of the present disclosure can comprise one DC power BUS for each of the “n” power modules, such that each of the “n” power modules is connectable to respective DC power sources.

In conclusion, the advantages of the photovoltaic solar inverter of the present disclosure are listed below:
Use of a transformer as a filter. The impedance of the transformer is used as a main coil of the filter:
   Elimination of coils→Reduction of weight and cost;
Use of a transformer with multiple secondary windings between power modules:
   Common mode choke between power modules;
   Use of interlinked switches;
Use of interlinked switches:
   Increase in the frequency of interest for filter design.
Increase in the frequency of interest of the filter:
   Reduction of the capacitive nature of the filter used;
   Greater filter design range (the resonance has a higher frequency range in which it does not generate problems);
Greater filter design range:
   Possibility of using the grid impedance as the secondary impedance of the filter.

### BRIEF DESCRIPTION OF THE DRAWINGS

FIG. 1 shows a photovoltaic solar inverter of the state of the art.

FIG. 2 shows the first embodiment (topology 1) of the photovoltaic solar inverter according to the present disclosure.

FIG. 3 shows an equivalent filter for the inverter shown in FIG. 2.

FIG. 4 shows the Bode plot of the resulting filter for the inverter of the present disclosure shown in FIG. 2 for different AC connection grids having different SCR values.

FIG. 5 shows the second embodiment (topology 2) of the photovoltaic solar inverter according to the present disclosure, with a multi-winding transformer and common DC BUS for supplying power to the power modules.

FIG. 6 shows the third embodiment (topology 3) of the photovoltaic solar inverter according to the present disclosure, with a multi-winding transformer and independent supply for the power modules.

FIG. 7 shows an equivalent filter for any of the inverters shown in FIGS. 5 and 6 with three working power modules.

FIG. 8 shows a Bode plot for the filter shown in FIG. 7.

FIG. 9 shows the current in the capacitor of the LCL filter for any of the inverters shown in FIGS. 5 and 6, with three working power modules.

FIG. 10 shows an equivalent filter for any of the inverters shown in FIGS. 5 and 6 with two working power modules.

FIG. 11 shows a Bode plot for the filter shown in FIG. 10.

FIG. 12 shows the current in the capacitor of the LCL filter for any of the inverters shown in FIGS. 5 and 6, with two working power modules.

FIG. 13 shows a Bode plot for the filter shown in FIG. 12, with a single working power module.

FIG. 14 shows the current in the capacitor of the LCL filter for any of the inverters shown in FIGS. 5 and 6, with one working power module.

FIG. 15 shows the fourth embodiment (topology 4) of the photovoltaic solar inverter according to the present disclosure, with a multi-winding transformer, a winding dedicated to the capacitor, forming an LLCL filter.

FIG. 16 shows an equivalent filter for the inverter shown in FIG. 15.

### DETAILED DESCRIPTION OF THE INVENTION

### Reference List

1.—photovoltaic solar inverter of the state of the art;
2.—photovoltaic solar inverter of the state of the art;
3.—LCL filter of the state of the art;
4.—power stage of the state of the art;
5.—low to medium voltage transformer of the state of the art;
6.—medium voltage AC grid (36 KV);
   6a.—inductance of the AC grid;
7.—DC voltage source (photovoltaic plant, batteries, etc.);
8.—photovoltaic solar inverter of the present disclosure.
   8′.—photovoltaic solar inverter of the present disclosure—Topology 1.
   8″.—photovoltaic solar inverter of the present disclosure—Topology 2.
   8″.—photovoltaic solar inverter of the present disclosure—Topology 3.
   8″″.—photovoltaic solar inverter of the present disclosure—Topology 4.
9.—power module of the present disclosure;
10′.—low to medium voltage transformer of the present disclosure—Topology 1;
10″.—low to medium voltage transformer of the present disclosure—Topology 2;
10′″.—low to medium voltage transformer of the present disclosure—Topology 3;
10″″.—low to medium voltage transformer of the present disclosure—Topology 4;
   10a, 10b: primary winding (inductance) and secondary winding (inductance) of the transformer, respectively;
   10c: winding (inductance) of the low to medium voltage transformer specific for the capacitor;
11.—capacitor (capacitor bank with one capacitor per phase—three-phase);
12.—DC BUS.

The present disclosure takes advantage the transformer (low to medium voltage, for example) which converts the AC voltage at the outlet of the power modules (usually low voltage around 600V) into the AC grid voltage (usually medium voltage: 36 KV) to which the solar inverter is connected as part of new filter topologies for eliminating high frequency harmonics.

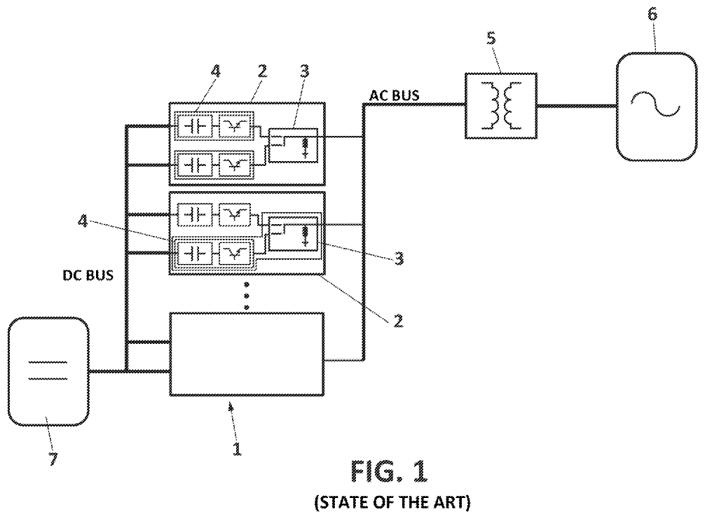

FIG. 1 shows an inverter 1 of the state of the art, wherein there are several power modules 2, each of which includes the power stage 4 and the LCL filter 3, the outlets of power modules 2 are connected to a common AC BUS, which is connected to the inlet of the low to medium voltage transformer 5. Therefore, the present disclosure eliminates the filter 3 as such from the power module and adds a new specific transformer which replaces the transformer 5 so that not only does it comply with the low to medium voltage transformation ratio, but it furthermore has a frequency behaviour equivalent to the “first L-” of the “LCL” filter. The capacitor “-C-” is added at the outlet of the new specific transformer and is also set/configured based on the response needed for the “LCL” filter. Lastly, the AC grid acts as the last “-L”, which depends on the SCR (Short Circuit Ratio) so its values are limited within a range. Advantage is thereby taken of two existing elements such as the low to medium voltage transformer and the AC grid as first and third elements (inductances) of the LCL filter, and the capacitor is only added to form the filter as a second intermediate element. This disclosure has the advantage that it eliminates the very heavy coils to form the inductances of the LCL filter 3 included in the power modules 2 of the inverters of the state of the art.

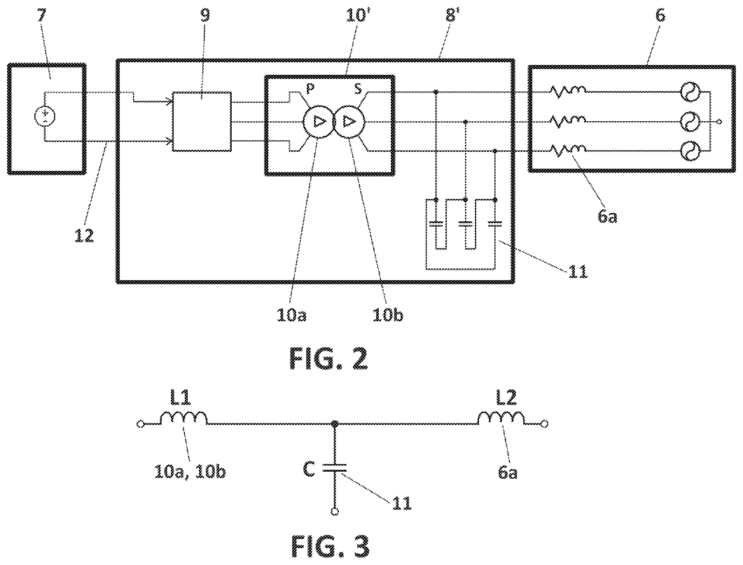

The first embodiment of the photovoltaic solar inverter 8′ (topology 1) is shown in FIG. 2. In this first embodiment, the topology of the “LCL” filter of the state of the art is replaced with a “transformer+capacitor” topology. This topology involves the elimination of three-phase secondary inductances (i.e., inductances of the block with reference 3 in FIG. 1 and additionally the capacitor in the same block). The photovoltaic solar inverter 8′ shown in FIG. 2 is a “simple” inverter with a single power module 9 (without inductance or a capacitor with which to form the LCL filter of the power module of the state of the art), wherein the transformer 10′ and the capacitor 11 are located on the side of the AC grid 6. The “LCL” filter is completed with the inductance “L₂” 6a that the AC grid has at the connection point. That is, the L-C-L filter is formed by the primary-secondary inductances 10a-10b of the specific transformer 10′ (L-), the also specific capacitor 11 (-C-) and the inductance 6a which is variable but limited (within a range dependent on the SCR) of the AC grid (-L) 6. The primary-secondary inductances 10a-10b of the specific transformer 10′ have an equivalent inductance L₁. The impedance of the transformer Z_{CC} is related to resistance R_{CC} and reactance X_{CC} by means of the expression Z_{CC}=R_{CC}+jX_{CC} and in turn reactance X_{CC} is related to inductance L₁: X_{CC}=2πL₁. Reactance X_{CC} is a parameter which has a certain margin of freedom in the design of the transformer. Therefore, by modifying the reactance X_{CC}, the inductance L₁ and with it the selection and response of the filter, are also modified. That is, the response of the filter is configured by selecting suitable values of “C” and “X_{CC}”.

The transfer function of the filter for the inverter shown in FIG. 2, which has a filter equivalent to the one shown in FIG. 3, is developed below. Namely, FIG. 3 shows the inductance “L₁” equivalent to the primary inductance 10a and secondary inductance 10b of the transformer 10′, and the capacitor “C” 11 and the equivalent grid inductance “L₂” 6a is also shown. The transfer function is:

$$\frac{I}{V} = \frac{1}{{s}^{3} \cdot {CL}_{1} {L}_{2} + s \cdot ( {L}_{1} + {L}_{2} )}$$

The equivalent inductance L₁ is determined by the transformer.

Data of the transformer:
V_{f-f_n}=660V (low side)
Sₙ=1.209 MVA
X_{cc}=8%
fₙ=50 Hz

$${L}_{1} = \frac{{X}_{c c} \cdot {V}_{n}^{2}}{2 π {f}_{n} \cdot {S}_{n}} = 76 µ H$$

Therefore:

The inductance L₂ is determined by the grid. For a defined SCR [2;5;10;30], the following is obtained:

$${L}_{2} = \frac{{V}_{n}^{2}}{2 π {f}_{n} \cdot SCR \cdot {S}_{n}} = [ 478 ; 191 ; 96 ; 32 ] µH$$

The capacitor “C” is designed to obtain the desired attenuation at the switching frequency of the inverter (3 kHz is considered). The resonant frequency thereof is decided for that purpose. By setting it at 1200 Hz, the following is true:

$$C = \frac{{L}_{1} + {L}_{2}}{{L}_{1} \cdot {L}_{2} \cdot {( 2 {πf}_{res} )}^{2}} = [ 267 ; 322 ; 414 ; 7 \; 82 ] µF$$

Once the foregoing has been calculated, a single capacitor that works for the entire design range can be designed. For example, by choosing C=350 μF:

$${f}_{res} = \sqrt{\frac{{L}_{1} + {L}_{2}}{{L}_{1} \cdot {L}_{2} \cdot C}} \text{/} 2 π = [ 1048 ; 1151 ; 1306 ; 1794 ] Hz$$

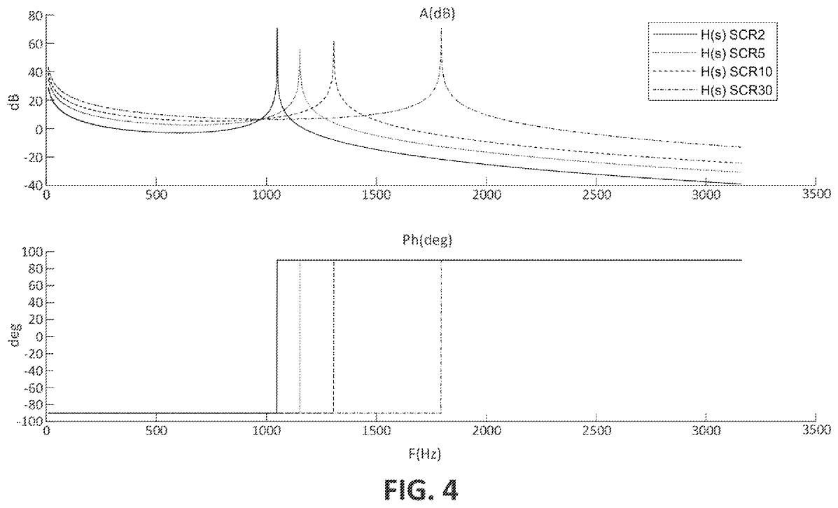

With the previous calculations, the Bode plot (see FIG. 4) of the resulting filter for the inverter of the present disclosure for the SCR values indicated above is obtained.

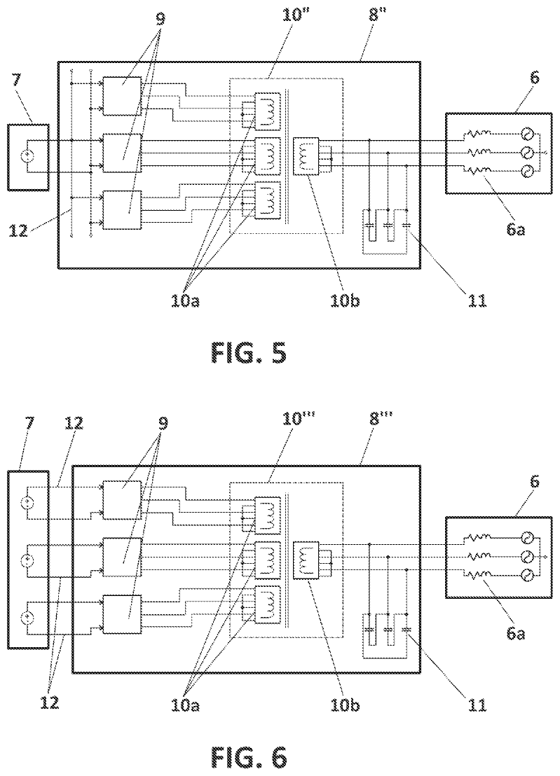

The second embodiment of the inverter 8″ (topology 2) of the present disclosure is shown in FIG. 5. The inverter 8″ shown in FIG. 5 is a modular inverter without inductances or a capacitor with which to form the LCL filter of the power module of the state of the art. The inverter 8″ has transformer 10″ with multi-winding 10a, plus the capacitor 11 on the grid side. On the DC side 7, the three power modules 9 are connected to respective independent input windings 10a of the transformer 10″, with the three power modules 9 being powered with DC BUS 12 common for all of them coming from the DC source 7, such as a photovoltaic solar power plant. The functions and advantages of the inverter 8″ are:
Raising/setting AC voltage between inverter and AC grid;
Differential inductance for AC current filtering (together with the capacitor on the grid side)
Common mode choke: this allows several power modules to work with a common DC BUS without common mode current recirculation. Interlinked operation of power modules.

The third embodiment 8′″ (topology 3) of the inverter of the present disclosure is shown in FIG. 6. The inverter 8′″ shown in FIG. 6 in a manner similar to that shown in FIG. 5, is an inverter modular without inductances or a capacitor with which to form the LCL filter of the power module of the state of the art. The inverter 8′″ has transformer 10′″ with multi-winding 10a, plus the capacitor 11 on the grid side AC 6. The only difference with respect to the inverter shown in FIG. 5 is that it has independent DC buses. That is, on the direct current DC side, each of the three power modules 9 has an independent power supply 7 which, for example, can be different photovoltaic solar fields or a hybrid configuration with inputs for a photovoltaic solar field and batteries. The functions and advantages of the inverter 8′″ are the same as those of the inverter 8″ shown in FIG. 5.

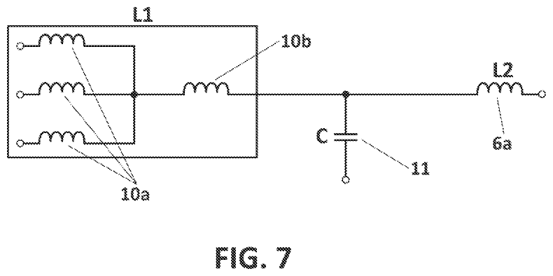

An equivalent filter model for the photovoltaic solar inverters 8″ and 8′″ of the present disclosure shown in FIGS. 5 and 6, respectively, are detailed below. In FIG. 7, the transformer 10″ or 10′″ is observed, represented as one inductance L₁ for each of the windings to which respective power modules 9 are connected. The equivalent model of the transformer 10″ or 10′″ for the different cases of use (one to three working power modules 9) can thereby be analysed. FIG. 7 also shows the capacitor “C” 11 and the grid inductance “L₂” 6a.

When working with this model, it will be necessary to define X_{CC} of the primary (X_{cc}^{pri}) and of the secondary (X_{cc}^{sec}). As a first approach, it can be assumed that Xcc is divided equally between the primary and secondary (X_{cc}^{pri}=X_{cc}^{sec}=0.5·X_{cc}).

The generic equation based on the number of power module to calculate L₁ is the following:

$${L}_{1} = ( x + \frac{( 1 - x ) \cdot n}{N} ) \frac{{X}_{c c} \cdot {V}_{n}^{2}}{2 π {f}_{n} \cdot {S}_{n}}$$

wherein “x” is the proportion of impedance of the medium side (single), “N” is the number of windings of the low working side and “n” is the total number of windings of the low side.

Mentioned again is the expression for the inductance of the AC grid “L₂”, which varies according to the SCR (Short Circuit Ratio), according to the following expression:

$${L}_{2} = \frac{{V}_{n}^{2}}{2 π {f}_{n} \cdot SCR \cdot {S}_{n}} .$$

Three Working Power Modules.

The case of three working power modules when the inverter has three power modules is analysed below. Taking the foregoing into account, the impedance of each secondary winding is three-fold (number of windings “n”=3); said value (X_{cc}^{sec_dev}=1.5·X_{cc}). The following can thereby be defined:

X_{cc}^{3/3}=X_{cc}^{pri}+X_{cc}^{sec_dev}/3=0.5·X_{cc}+0.5+X_{cc}=X_{cc}

X_{cc}^{2/3}=X_{cc}^{pri}+X_{cc}^{sec_dev}/2=0.5·X_{cc}+0.75+X_{cc}=1.25·X_{cc}

X_{cc}^{1/3}=X_{cc}^{pri}+X_{cc}^{sec_dev}==0.5·X_{cc}+1.5+X_{cc}=2·X_{cc}

When working with three power modules 9, the operation is similar to the case of the inverter 8′ of the first embodiment of the disclosure shown in FIG. 2, the equivalent filter of which can be carried out in a manner similar to that described for FIG. 3. The main difference with the inverter shown in FIG. 2 is that the power modules 9 work interlinked, with the switching frequency to be attenuated by the filter being three times higher than the switching frequency of the power modules (3 kHz in the power modules and 9 kHz is the frequency of interest for the filter).

The equivalent per power module for filter design can be calculated taking into account that N=n=3, x=0.5 and SCR [2, 5, 10, 30]:

$${L}_{1} = ( x + \frac{( 1 - x ) \cdot n}{N} ) \frac{{X}_{c c} \cdot {V}_{n}^{2}}{2 π {f}_{n} \cdot {S}_{n}} = ( 0.5 + \frac{1.5}{3} ) \frac{{X}_{c c} \cdot {V}_{n}^{2}}{2 π {f}_{n} \cdot {S}_{n}} = \frac{{X}_{c c} \cdot {V}_{n}^{2}}{2 π {f}_{n} \cdot {S}_{n}} = 76 µH$$

$${L}_{2} = \frac{{V}_{n}^{2}}{2 π {f}_{n} \cdot SCR \cdot {S}_{n}} = [ 478 ; 191 ; 96 ; 32 ] µH$$

In this case L₁ and L₂ have the same value as in the previous case, and the main difference is that the capacitor will be designed to resonate the filter at 3600 Hz for the different SCR values [2, 5, 10, 30], whereby:

$$C = \frac{{L}_{1} + {L}_{2}}{{L}_{1} \cdot {L}_{2} \cdot {( 2 π {f}_{res} )}^{2}} = [ 30 ; 36 ; 46 ; 87 ] µF$$

Once the foregoing has been calculated, a single capacitor that works for the entire design range can be designed. For example, by choosing C=70 μF:

$${f}_{res} = \sqrt{\frac{{L}_{1} + {L}_{2}}{{L}_{1} \cdot {L}_{2} \cdot C}} \text{/} 2 π = [ 2344 , 2575 , 2919 , 40 \; 12 ] Hz$$

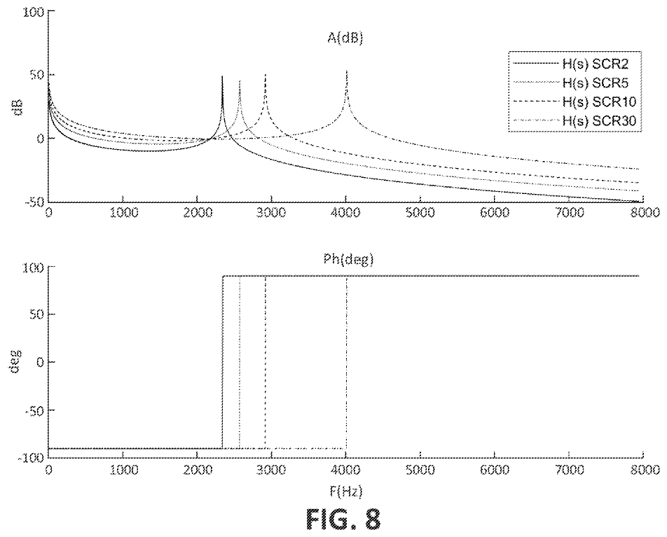

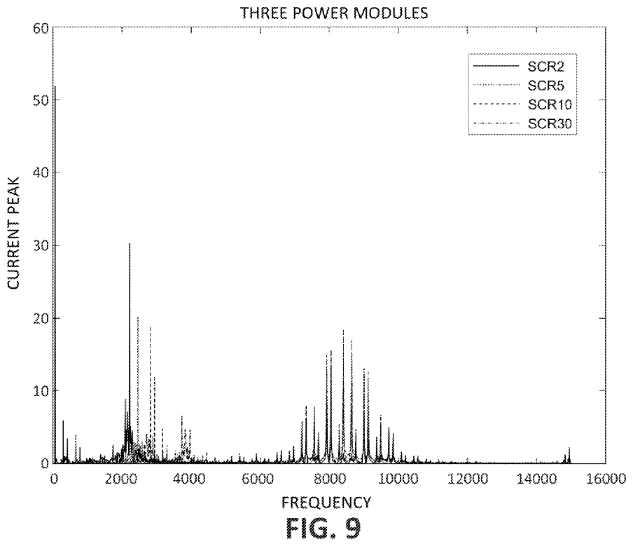

With the previous calculations, the Bode plot (see FIG. 8) of the resulting filter for the inverter of the present disclosure according to the second embodiment 8″ and third embodiment 8′″ of the disclosure for SCR values [2, 5, 10, 30] and with three working power modules, is obtained. FIG. 9 shows the current in the capacitor “C” 11 of the LCL filter for said inverter 8″ or 8′″ and the same SCR values.

Two Working Power Modules

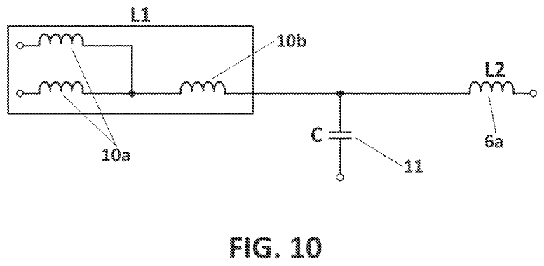

The case of two working power modules when the inverter has three power modules in total is analysed below. With the previous considerations, the model of the photovoltaic solar inverter of the second embodiment 8″ and third 8′″ embodiment (FIG. 5 and FIG. 6, respectively) can be determined working with two of the three power modules and their main equivalent inductance L₁. The filter equivalent working with two power modules 9 is shown in FIG. 10, wherein the main inductance L₁ equivalent to inductances 10a and 10b is shown. FIG. 10 also shows the capacitor 11 and the equivalent grid inductance 6a L₂ of the AC grid. The equivalent inductance L₁ is calculated as follows:

$${L}_{1} = ( x + \frac{( 1 - x ) \cdot n}{N} ) \frac{{X}_{cc} \cdot {V}_{n}^{2}}{2 π {f}_{n} \cdot {S}_{n}} = ( 0.5 + \frac{( 1 - 0.5 ) \cdot 3}{2} ) \frac{{X}_{cc} \cdot {V}_{n}^{2}}{2 π {f}_{n} \cdot {S}_{n}} = 1.25 \cdot \frac{{X}_{cc} \cdot {V}_{n}^{2}}{2 π {f}_{n} \cdot {S}_{n}} = 95 μ H$$

With the value of the capacitor “C” defined for the operation with three power modules, C=70 μF, a resonant frequency is obtained:

$${f}_{res} = \sqrt{\frac{{L}_{1} + {L}_{2}}{{L}_{1} \cdot {L}_{2} \cdot C}} \text{/} 2 π = [ 2132 , 2384 , 2752 , 3892 ] Hz$$

As can be observed, the filter with two power modules is very similar to the filter with three power modules. The main difference is that the frequency of interest for the filter will only be 6 kHz, according to the circumstance of 3 kHz switching in the power modules 4.

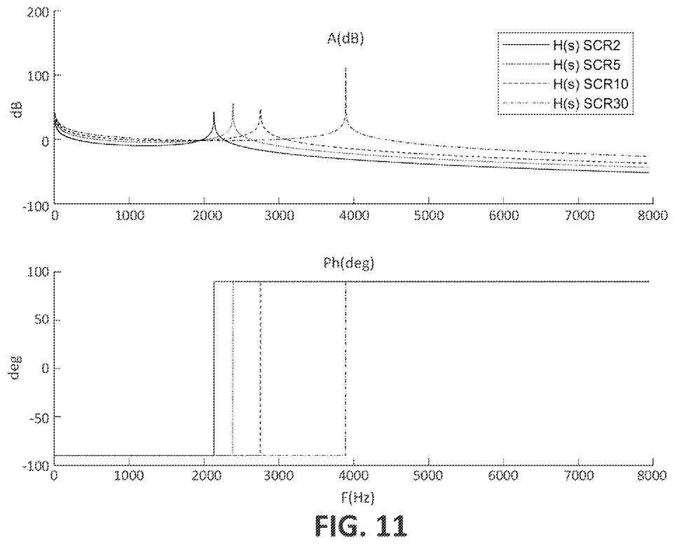

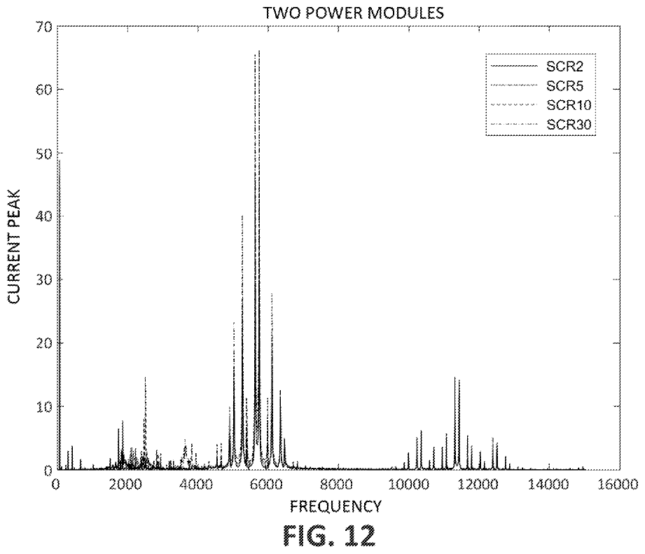

With the previous calculations, the Bode plot (see FIG. 11) of the resulting filter for the inverter of the present disclosure according to the second embodiment 8″ and third embodiment 8′″ of the disclosure (topologies 2 and 3) for SCR values [2, 5, 10, 30] and with two working power modules, is obtained. FIG. 12 shows the current in the capacitor 11 of the LCL filter (L₁CL₂) for said embodiments of the inverter and the same SCR values.

One Working Power Module

The case of one working power module when the inverter has three power modules is analysed below. Lastly, with a power module 9 and the same circumstances as in the previous cases for two and three power modules:

$${L}_{1} = 2 \cdot \frac{{X}_{cc} \cdot {V}_{n}^{2}}{2 π {f}_{n} \cdot {S}_{n}} = 153 μ H$$

With the same value of the capacitor defined for the operation of two and three modules of 70 μF, resonant frequencies for different SCR values [2, 5, 10, 30] are obtained:

$${f}_{res} = \sqrt{\frac{{L}_{1} + {L}_{2}}{{L}_{1} \cdot {L}_{2} \cdot C}} \text{/} 2 π = [ 1768 , 2064 , 2481 , 3705 ] Hz$$

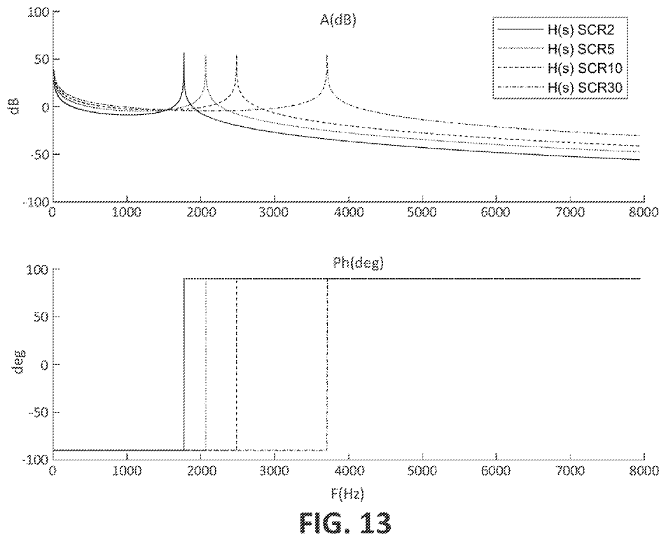

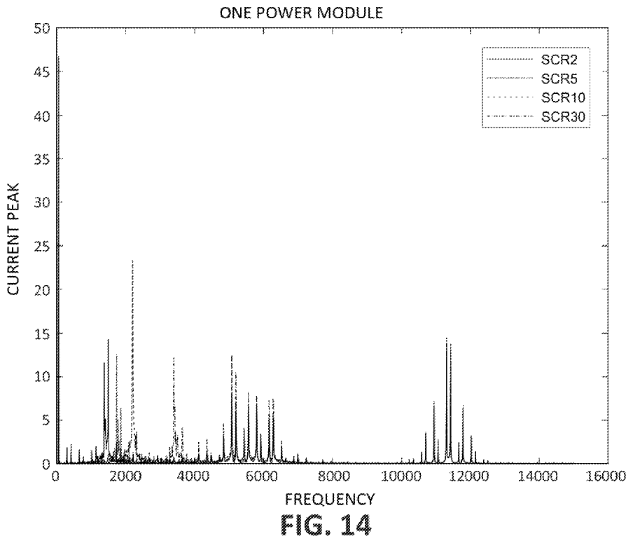

With the previous calculations, the Bode plot (see FIG. 13) of the resulting filter for the inverter of the present disclosure according to the second embodiment 8″ and third embodiment 8′″ of the disclosure (topologies 2 and 3) for SCR values [2, 5, 10, 30] and with one working power module, is obtained. FIG. 14 shows the current in the capacitor of the LCL filter for said embodiments of the inverter and the same SCR values. However, given the resonances of the filter, for one power module it is mandatory to increase the switching frequency. In this example, up to 6 kHz.

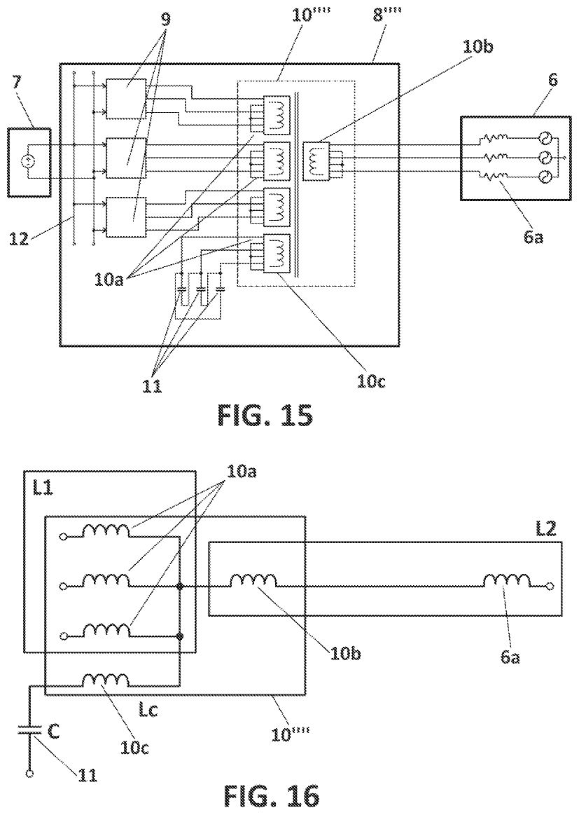

The fourth 8″″ embodiment of the photovoltaic solar inverter is shown in FIG. 15 (Topology 4). In this case of the fourth embodiment 8″″ the resulting filter is LLCL. The equivalent filter is shown in FIG. 16, wherein the filter is made up of L₁L_{C}CL₂. Inductance L₁ is the inductance equivalent to the three inductances 10a of the primary of the transformer 10″″. Inductance L₂ is the inductance equivalent to the inductance 10b of the secondary of the transformer 10“ ” and of the inductance 6a of the AC grid 6. The primary of the transformer has an additional inductance 10c which will be inductance “L_{C}”, dedicated to the capacitor 11, such that the capacitor 11 is connected between the inductance 10c and ground. The design of the capacitor bank 11 would be dual, being adapted to the slot at the frequency of 6 and 9 kHz (two or three times the switching frequency).

The transfer function of the L₁L_{C}CL₂ filter is:

$$\frac{I}{V} = \frac{{s}^{2} \cdot {CL}_{c} + 1}{C \cdot ( {L}_{1} {L}_{2} + {L}_{c} ( {L}_{1} {L}_{2} ) ) \cdot {s}^{3} + s \cdot ( {L}_{1} + {L}_{2} )}$$

And the values of L₁L_{C}CL₂ are calculated as follows:

$${L}_{1} = ( \frac{( 1 - x ) \cdot n}{N} ) \frac{{X}_{cc} \cdot {V}_{n}^{2}}{2 π {f}_{n} \cdot {S}_{n}} ; C = \frac{{L}_{1} {L}_{2}}{( {L}_{1} {L}_{2} + {L}_{c} ( {L}_{1} + {L}_{2} ) ) \cdot {( 2 π {f}_{res} )}^{2}} ;$$

$${L}_{c} = \frac{1}{C \cdot {( 2 π {f}_{res} )}^{2}}$$

wherein:
“N” is the number of windings of the low working side and “n” is the total number of windings of the low voltage side;
X_{CC} is the configurable element based on the frequency response needed for the LLCL filter;
x: proportion of impedance of the medium side (single; if, for example, Xcc is divided by 50%, x=0.5),
Sₙ is the nominal power of the transformer;
Vₙ is the nominal voltage of the transformer on the low side (power module side);
fₙ is the working frequency of the low side (usually 50 or 60 Hz);
fᵣₑₛ is the resonant frequency of the LLCL filter;
   and knowing that:

L₂=L_{M}+L_{P}, wherein:

$${L}_{m} = ( x ) \frac{{X}_{cc} \cdot {V}_{n}^{2}}{2 π {f}_{n} \cdot {S}_{n}}$$

L_{P} is the inductance of the AC grid which varies according to the SCR (Short Circuit Ratio) according to the following expression:

$${L}_{P} = \frac{{V}_{n}^{2}}{2 π {f}_{n} \cdot SCR \cdot {S}_{n}} .$$

1. A photovoltaic solar inverter with an alternating current (AC) grid filter without inductance, wherein the photovoltaic solar inverter is connectable to the AC grid;
wherein the inverter comprises:
at least one power module for converting a direct current (DC) input voltage into a three-phase AC output voltage;
a three-phase AC/AC transformer for adapting the three-phase AC output voltage of the at least one power module to the three-phase AC voltage of the AC grid, which has an inductance, referred to as L₂;
wherein the three-phase AC/AC transformer comprises:
at least one winding on a low voltage side connected to the at least one power module;
at least one winding on a grid side connectable in series with the AC grid;
wherein the at least one winding on the low voltage side connected to the at least one power module together with the at least one winding on the grid side have an equivalent inductance, referred to as L₁;
a capacitor, referred to as C, connected to the winding of the grid side of the three-phase AC/AC transformer;
wherein the equivalent inductance, referred to as L₁, of the AC/AC transformer, the capacitor, referred to as C, and the inductance, referred to as L₂, of the AC grid form a high frequency inductance-capacitance-inductance (LCL) filter, such that the values of the equivalent inductance, referred to as L₁, and of the capacitor, referred to as C, are calculated based on a frequency response of the LCL filter according to the following expressions:
$${L}_{1} = \frac{{X}_{cc} \cdot {V}_{n}^{2}}{2 π {f}_{n} \cdot {S}_{n}} and C = \frac{{L}_{1} + {L}_{2}}{{L}_{1} \cdot {L}_{2} \cdot {( 2 π {f}_{res} )}^{2}}$$
wherein:
X_{CC}: is an equivalent impedance of a plurality of windings of the three-phase AC/AC transformer;
Sₙ: is a nominal power of the three-phase AC/AC transformer;
Vₙ: is a nominal voltage of the three-phase AC/AC transformer on the low voltage side;
fₙ: is a working frequency;
fᵣₑₛ: is a resonant frequency of the LCL filter; and
L₂: is an inductance of the AC grid which varies according to a Short Circuit Ratio (SCR) according to the following expression:
$${L}_{2} = \frac{{V}_{n}^{2}}{2 π {f}_{n} \cdot SCR \cdot {S}_{n}} .$$

2. The photovoltaic solar inverter with the AC grid filter without inductance according to claim 1, wherein the photovoltaic solar inverter further comprises a number, n, of power modules each connected to a respective winding on the low voltage side of the three-phase AC/AC transformer, such that the equivalent inductance, referred to as L₁, is calculated by means of:
$${L}_{1} = ( x + \frac{( 1 - x ) n}{N} ) \frac{{X}_{cc} \cdot {V}_{n}^{2}}{2 π {f}_{n} \cdot {S}_{n}}$$
wherein:
x: is a proportion of impedance of the grid side;
N: is a number of windings of a low working side; and
n: is a total number of windings of the low voltage side.

3. The photovoltaic solar inverter with the AC grid filter without inductance according to claim 2, wherein the photovoltaic solar inverter comprises a single DC power BUS for powering the number, n, of power modules, and wherein the single DC BUS is connectable to at least one DC power source.

4. The photovoltaic solar inverter with the AC grid filter without inductance according to claim 2, wherein the photovoltaic solar inverter comprises one DC power BUS for each of the number, n, of power modules, such that each of the number, n, of power modules is connectable to a respective DC power source.

5. A photovoltaic solar inverter with an AC grid filter without inductance, wherein the photovoltaic solar inverter is connectable to the AC grid;
the photovoltaic solar inverter comprising:
at least one power module for converting a DC input voltage into a three-phase AC output voltage;
a three-phase AC/AC transformer for adapting the three-phase AC output voltage of the power module to the three-phase AC voltage of the AC grid, which has an inductance, referred to as Lₚ;
wherein the three-phase AC/AC transformer comprises:
at least one winding on a first low voltage side connected to the at least one power module and with an equivalent inductance, referred to as L₁;
at least one winding on a second low voltage side connected to a capacitor, referred to as C, and with an inductance, referred to as L_{c};
at least one winding on a grid side connectable in series with the AC grid, wherein the at least one winding on the grid side has an equivalent inductance, referred to as L_{M}; and
the capacitor, referred to as C;
wherein the equivalent inductance, referred to as L₁, of the AC/AC transformer, the inductance, referred to as L_{c}, the capacitor, referred to as C, and an inductance, referred to as L₂, resulting from adding the inductance, referred to as Lₚ, and the equivalent inductance referred to as L_{M}, form a high frequency filter with LLCL typology, such that the values of the equivalent inductance, referred to as L₁, and of the capacitor, referred to as C, are calculated based on the frequency response of the LLCL filter according to the following expressions:
$${L}_{1} = ( 1 - x ) \frac{{X}_{cc} \cdot {V}_{n}^{2}}{2 π {f}_{n} \cdot {S}_{n}} ; C = \frac{{L}_{1} + {L}_{2}}{( {L}_{1} {L}_{2} + {L}_{c} ( {L}_{1} + {L}_{2} ) ) \cdot {( 2 π {f}_{res} )}^{2}} ;$$
$${L}_{cv} = \frac{1}{C \cdot {( 2 π {f}_{res} )}^{2}} ;$$
wherein:
X_{CC} is a configurable element based on a frequency response needed for the LLCL filter;
x: is a proportion of impedance of a medium side;
Sₙ: is a nominal power of the three-phase AC/AC transformer;
Vₙ: is a nominal voltage of the three-phase AC/AC transformer on a low side;
fₙ: is a working frequency of the low side;
fᵣₑₛ: is a resonant frequency of the LLCL filter;
and knowing that:
L₂=L_{M}+L_{P}, wherein:
$${L}_{m} = ( x ) \frac{{X}_{cc} \cdot {V}_{n}^{2}}{2 π {f}_{n} \cdot {S}_{n}} ;$$
L_{P}: is an inductance of the AC grid which varies according to a Short Circuit Ratio “SCR” according to the following expression:
$${L}_{P} = \frac{{V}_{n}^{2}}{2 π {f}_{n} \cdot SCR \cdot {S}_{n}} .$$

6. The photovoltaic solar inverter with the AC grid filter without inductance according to claim 5, wherein the photovoltaic solar inverter further comprises a number, n, of power modules each connected to a respective winding on the first low voltage side of the three-phase AC/AC transformer, such that the equivalent inductance, referred to as L₁, is calculated by means of:
$${L}_{1} = ( \frac{( 1 - x ) \cdot n}{N} ) \frac{{X}_{cc} \cdot {V}_{n}^{2}}{2 π {f}_{n} \cdot {S}_{n}}$$
wherein:
x: is a proportion of an impedance of a medium side;
N: is a number of windings of a low working side; and
n: is a total number of windings of the first low voltage side.

7. The photovoltaic solar inverter with the AC grid filter without inductance according to claim 6, wherein the photovoltaic solar inverter comprises a single DC power BUS for powering the number, n, of power modules, and wherein the single DC BUS is connectable to at least one DC power source.

8. The photovoltaic solar inverter with the AC grid filter without inductance according to claim 6, wherein the photovoltaic solar inverter comprises one DC power BUS for each of the number, n, of power modules, such that each of the number, n, of power modules is connectable to a respective DC power source.
